(19) United States
(12) Patent Application Publication
(10) Pub. No.: US 2021/0001456 A1
(43) Pub. Date: Jan. 7, 2021

(54) PLIERS-VALVE-WHEEL COMBINATION TOOL

(71) Applicants: JEREMY FOURNIER, THIBODEAUX, LA (US); KEITH MILLER, EDGARD, LA (US)

(72) Inventors: JEREMY FOURNIER, THIBODEAUX, LA (US); KEITH MILLER, EDGARD, LA (US)

(21) Appl. No.: 16/502,558

(22) Filed: Jul. 3, 2019

(51) Int. Cl. B25B 7/22; B25B 7/04; B25B 13/50

(52) U.S. Cl. CPC B25B 7/22; B25B 13/5008; B25B 7/04

(57) ABSTRACT

A pliers-valve-wheel combination tool for safe and efficient working upon systems and equipment having large wheeled valves, from a ladder, lift, or platform, often with only one hand free, providing adjustable pliers for performing various maintenance tasks and a valve-wheel wrench for quickly, efficiently, and safely manipulating valves in both expected and unexpected circumstances, without a cumbersome change of tools.

### BACKGROUND OF THE INVENTION

This invention provides a pliers-valve-wheel combination tool for safe and efficient working upon systems and equipment having large wheeled valves.

Maintenance work, including building, inspecting, maintaining, retrofitting, and taking down systems and equipment for drilling, refining, transporting, manufacturing, and other industrial activities requires working with large wheeled valves on pipes or tubes. Often such valves are located in hard-to-access places of considerable height, depth, or distance from any comfortable and safe place to stand, and require the use of ladders, lifts, or platforms. Often only one hand is free to manipulate a tool, with the other hand being required to hold on to a support. Working from such ladders, lifts, or platforms requires a maintenance person to assemble and carry all needed and possibly needed tools before setting off, usually on a tool belt or in a tool kit, and, when a needed tool is not already in hand, requires taking up the tool while maintaining balance, possibly after replacing a different tool already in hand. Each different tool adds weight and bulk to the tool belt or kit.

When working on systems having valves on pipes or tubes, circumstances arise where any given valve needs to be opened or closed as quickly as possible, such as when an unexpected leak or blockage arises, possibly as a bad result of the maintenance work being done. Valve wheels are often at a temperature too extreme to grasp directly with the gloved hand, and are most likely to be too difficult to turn even with two hands, where often only one hand is free. Valve-wheel wrenches are known in the art, which facilitate the turning of valve wheels. However, in circumstances where only one hand is free to perform work, and where that one hand already has a different tool in it, critical time is spent putting up the different tool and taking up the valve-wheel wrench, possibly under stressful circumstances which might lead to fumbling and dropping of the tools.

What is needed is a combination tool providing adjustable pliers for performing various maintenance tasks and a valve-wheel wrench for quickly, efficiently, and safely manipulating valves in both expected and unexpected circumstances, without a cumbersome change of tools.

U.S. Pat. No. 1,321,777 for a “Compound Tool,” issued on Nov. 11, 1919 to inventor Stephen Stepanian, claims a wrench comprising a stationary and a movable jaw, said stationary jaw terminating in an integral handle having a depression formed therein, a guide member for said movable jaw slidably positioned within a recess formed in said stationary jaw, said guide member being provided with a toothed edge, a nurled manipulating screw engaging with the ed e of said guide member to permit of the adjustment of said movable jaw with respect to said stationary jaw, a slidable bar positioned within the depression of said handle and arranged to be manually moved so that one of its extremities nay be forced into or out of engagement with the nurled portions of said screw in order ‘to retain the adjustments of the latter, and a resilient manipulating extremity formed upon one end of, said bar, said extremity being disposed for engagement with a pair of notches formed in the depression of said handle, whereby said bar may be maintained in or out of engagement with said screw.

U.S. Design Pat. No. D136,188 for a “Design for a Combined Wrench and Pliers,” issued on Aug. 17, 1943 to inventor William R. Payne.

U.S. Design Pat. No. D119,441 for a “Design for Battery Pliers,” issued on Mar. 12, 1940 to inventor William A. Sandy.

U.S. Pat. No. 7,845,254 for a “Firefighter Pocket Tool,” issued on Dec. 7, 2010 to inventor Mike Lionel, provides for a firefighter pocket tool that combines the functional features of several traditional tools (slip groove pliers of the curved jaw type, 6 in 1 screwdriver, spanner wrench, gas shut off tool and a striking tool) onto a shared single structure. The tool comprises a pair of slip groove plier members each having a jaw portion, a joint portion and a handle portion, a pivotal bolt, nut and spring member. Upon the upper rear portion of the pliers' upper jaw's head there is formed a protrusion that forms a striking surface and a hook and claw which can be used as a spanner for rocker lug type and similar fire hose couplings. A gas shut off loop can be used as a guard for fingers when the tool is being used as a striking implement.

U.S. Pat. No. 8,485,074 for a “Firefighter Tool,” issued on Jul. 16, 2013 to inventor Terry C. Farrell, provides for a firefighter tool that has pivotably connected handles and jaws, and one handle has an outer generally sinusoidal surface and the handle end is formed with a hook facingly disposed to the generally sinusoidal surface. The handles open fully so that the user grips the other handle and the sinusoidal surface hook alternately operably contactingly engages differently sized and configured fire hose couplings.

U.S. Pat. No. 4,995,128 for an “Electrician's Combination Tool,” issued on Feb. 26, 1991 to inventors Robert D. Montgomery et al., provides for a combination electrician's tool which is substantially a pair of pliers in which the handles are parallel to each other and having at one of its handle ends a crescent wrench while the other handle end has means to accept various tips such as screwdriver tips, sockets, etc. and gripping means to put pressure on the tips and the other handle being turned crossways can act as a torque wrench. The tool also has cutting, stripping and crimping means and one of the jaw sections can engage and hold a slotted screw.

U.S. Pat. No. 3,946,453 for a “Combination Plier, Wrench and Screwdriver Tool,” issued on Mar. 30, 1976 to inventor Ruben J. Tones, provides for a combination tool of the plier type which includes a screwdriving blade at one plier jaw point and wrench means presenting a smooth pressing surface at the end of both of the arms connected to the screwdriving blade. The other arm of the plier may be held at a right angle and serves as a lever arm when the tool is used for driving or loosening screws. The wrench means may be a pair of coaxially aligned different sized box wrenches formed unitarily, or a unitarily formed pair of open wrenches opening to the side and may be formed at the ends of each plier arm to provide four different sized wrenches.

U.S. Pat. No. 2,819,633 for “Eye-Screw Bending Pliers,” issued on Jan. 14, 1958 to inventor John F. Boehnke, provides for a tool where the first pliers handle member terminates in a screw driver tool, the second handle member terminates in a box wrench, and outer edges of the handle members adjacent the pivot point have co-operating cutting-edged grooves formed therein to make a wire cutting tool.

U.S. Pat. No. 1,459,531 for a “Combination Tool,” issued on Jun. 19, 1923 to inventor Emil J. Hanson, claims a combination tool having shanks pivotally connected for relative swinging movement and provided adjacent to their pivotal points with complemental plier jaws, one of said shanks being provided at the opposite end with a rigid wrench jaw and the other with a terminal tooth, and a sliding wrench jaw mounted upon the first-named shank and provided with an obliquely disposed ratchet face for engagement by the terminal tooth of the second-named shank as a means of respectively limiting the opening movement of the wrench jaws and the closing movement of the plier jaws.

U.S. Pat. No. 1,522,695 for a “Combination Wrench and Pliers,” issued on Jan. 13, 1925 to inventor William Noreen, provides for a combination tool comprising two complete tools, one of which tools has pivotally connected levers and the other of which tools has a handle into which one of the levers of the first-noted tool is slidably engageable, means for locking the other level of said first-noted tool to the handle of said second-noted tool, the levers of said first-noted tool having cooperating jaws, the two tools being thus connected with the jaws of said first-noted tool projecting and forming an extension of the handle of said second-noted tool.

### SUMMARY OF THE INVENTION

This invention provides a pliers-valve-wheel combination tool for safe and efficient working upon systems and equipment having large wheeled valves, from a ladder, lift, or platform, often with only one hand free, providing adjustable pliers for performing various maintenance tasks and a valve-wheel wrench for quickly, efficiently, and safely manipulating valves in both expected and unexpected circumstances, without a cumbersome change of tools.

### BRIEF DESCRIPTION OF THE DRAWINGS

Reference will now be made to the drawings, wherein like parts are designated by like numerals, and wherein:

FIG. 1 is a perspective view of the pliers-valve-wheel combination tool of the invention;

FIG. 2 is a plan view of the pliers-valve-wheel combination tool of the invention;

FIG. 3 is a perspective view of the pliers-valve-wheel combination tool of the invention in use as pliers; and

FIG. 4 is a perspective view of the pliers-valve-wheel combination tool of the invention in use as a valve-wheel wrench.

### DETAILED DESCRIPTION OF THE INVENTION

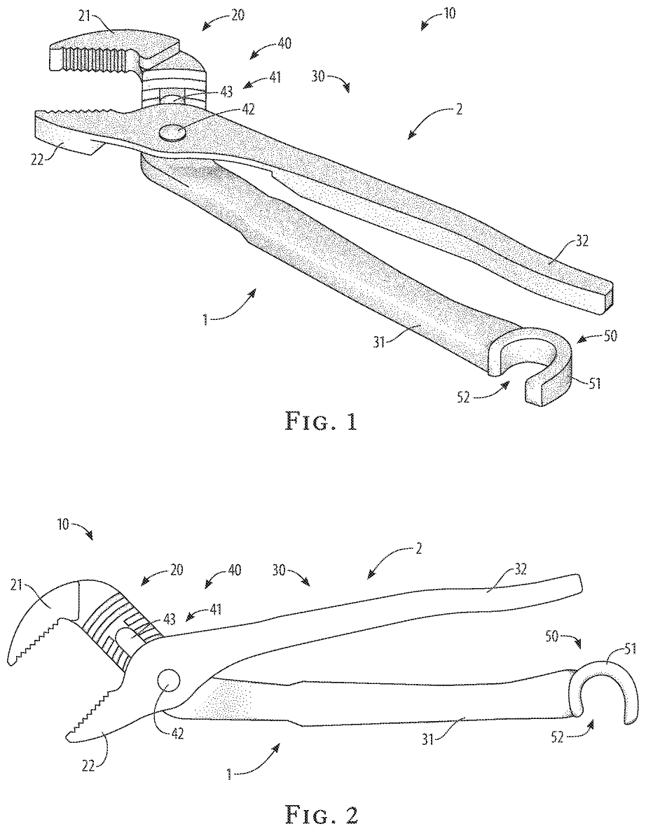

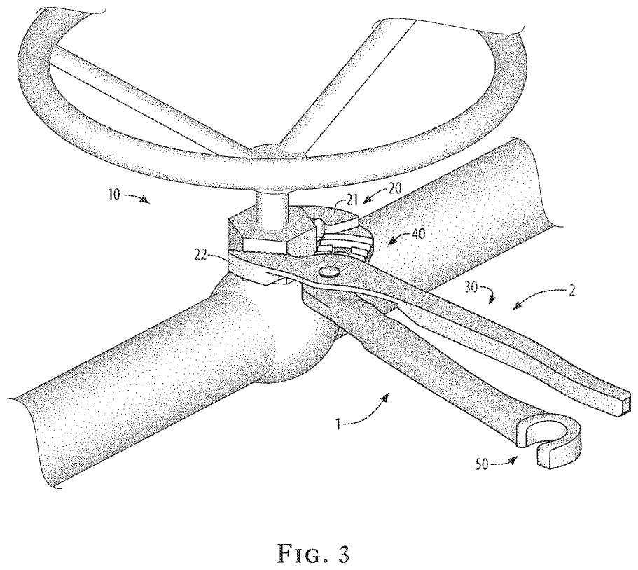

Referring to FIG. 1 and FIG. 2, the pliers-valve-wheel combination tool 10 is shown. The pliers-valve-wheel combination tool 10 provides a set of jaws 20, a set of handles 30, a fulcrum 40 between the jaws 20 and the handles 30, and a valve-wheel-wrench unit 50. A primary unit 1 provides a primary jaw 21, a primary handle 31, and a valve-wheel-wrench structure 51. The valve-wheel-wrench structure 51 is located on the primary unit 1 at the end opposite the primary jaw 21. The valve-wheel-wrench structure 51 defines a valve-wheel-wrench opening 52, forming the valve-wheel-wrench unit 50.

A secondary unit 2 provides a secondary jaw 22 and a secondary handle 32. The fulcrum 40 is formed by a slip joint 41 having a pivot pin 42 and a pivot slot 43, which joins the primary unit 1 and the secondary unit 2 in such a way as to make the size of the jaw opening adjustable, as known in the art. In an embodiment of the pliers-valve-wheel combination tool 10 the slip joint 41 is a groove joint, as known in the art. In an embodiment, the jaws 20 are at an angle to the handles 30, as known in the art.

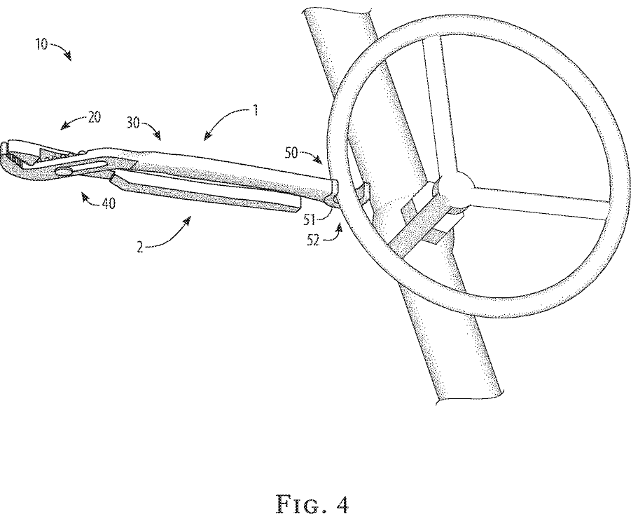

Referring to FIG. 3 and FIG. 4, in use the pliers-valve-wheel combination tool 10 is used in one way for gripping, clamping, or turning parts of the system being worked on, and can be quickly used another way to turn a valve wheel to open, close, or adjust the valve. The user is able to change very quickly, and to change back and forth, between the adjustable-pliers use and the valve-wheel-wrench use, with one hand, without any putting away or taking up of separate tools, and therefore without having to let go of anything gripped in the other hand, and without any loss of focus or concentration on the task. Also, the overall weight and bulk of the tool belt or tool kit brought to the location of the work being done is reduced in comparison to the use of separate tools.

Many other changes and modifications can be made in the present invention without departing from the spirit thereof. I therefore pray that my rights to the present invention be limited only by the scope of the appended claims.

I claim:

1. A pliers-valve-wheel combination tool comprising:
(i) a primary unit comprising at a first end a primary jaw, intermediately a primary handle, and at an opposite end a valve-wheel-wrench unit comprising a valve-wheel-wrench structure defining a valve-wheel-wrench opening;
(ii) a secondary unit comprising a secondary jaw and a secondary handle;
where said primary jaw and said secondary jaw form a set of jaws at a first end;
where said primary handle and said secondary handle form a set of handles toward an opposite end; and
(iii) a fulcrum formed between said jaws and said handles, comprising a slip joint, in turn comprising a pivot pin and a pivot slot;
where, in use, said slip joint provides adjustment of the distance between said jaws.

2. The pliers-valve-wheel combination tool of claim 1, where said slip joint further comprises a groove joint.

3. The pliers-valve-wheel combination tool of claim 1, where said jaws are placed at an angle to said handles.

4. The pliers-valve-wheel combination tool of claim 1, where said valve-wheel-wrench opening is placed facing away from said secondary handle.

5. A pliers-valve-wheel combination tool comprising:
(i) a primary unit comprising at a first end a primary jaw, intermediately a primary handle, and at an opposite end a valve-wheel-wrench unit comprising a valve-wheel-wrench structure defining a valve-wheel-wrench opening;
(ii) a secondary unit comprising a secondary jaw and a secondary handle;
where said primary jaw and said secondary jaw form an angled set of jaws at a first end;
where said primary handle and said secondary handle form a set of handles toward an opposite end;
where said valve-wheel-wrench opening on said primary unit faces away from said secondary handle; and
(iii) a fulcrum formed between said jaws and said handles, comprising a slip joint, in turn comprising a pivot pin and a pivot slot;
where, in use, said slip joint provides adjustment of the distance between said jaws.
